(19) United States
(12) Patent Application Publication
(10) Pub. No.: US 2025/0170580 A1
(43) Pub. Date: May 29, 2025

(54) MINCER

(71) Applicant: SHUANGMA PLASTIC MANUFACTURING INC., Taizhou (CN)

(72) Inventor: Cuihong CHEN, Taizhou (CN)

(21) Appl. No.: 18/545,393

(22) Filed: Dec. 19, 2023

(30) Foreign Application Priority Data
Nov. 27, 2023 (CN) 202323201969.9

(51) Int. Cl. B02C 18/30

(52) U.S. Cl. CPC B02C 18/305

(57) ABSTRACT

A mincer includes a container, a cover body and a flipping cover. The container is provided with a cavity for accommodating an object and an opening communicated with the cavity; the cover body is detachably installed on the container to seal the opening and provided with a feeding port communicated with the cavity; and the flipping cover is hinged with the cover body and rotated to cover or expose the feeding port. In the present invention, when the materials need to be added for the second time, the flipping cover is turned over to expose the feeding port. The materials are added for the second time into the container through the feeding port, and then the flipping cover is turned over again, so that the flipping cover covers the feeding port.

### CROSS REFERENCE TO RELATED APPLICATIONS

This application claims foreign priority of Chinese Patent Application No. 202323201969.9, filed on Nov. 27, 2023 in the China National Intellectual Property Administration, the disclosures of all of which are hereby incorporated by reference.

### TECHNICAL FIELD

The present invention relates to the technical field of food processing, in particular to a mincer.

### BACKGROUND OF THE PRESENT INVENTION

With the improvement of human quality of life, tools in a kitchen have also changed quickly. In order to facilitate food processing of people in daily cooking, a variety of food processors have been designed.

For example, the patent with publication number CN208301543U discloses a novel drawstring food processor, which comprises a container and a food processing device installed in the container. A cover body is detachably covered above the container. A driving assembly for driving the food processing device to rotate is arranged in the cover body. The driving assembly comprises an internal rotating assembly and an external power starting device. The power starting device comprises a pull connection device which is connected to the rotating assembly. Through the design of the power starting device and the rotating assembly in the present invention, only the power starting device is required to be pulled to process food by the food processing device inside the container, which is convenient and simple to use, high in working efficiency and time saving. Moreover, the food processing device can be replaced according to different needs and has a wide application range.

However, in a mincing process of the mincer, when materials are added to the container, the cover body needs to be disassembled again, which is very troublesome.

### SUMMARY OF PRESENT INVENTION

With respect to the above problems in the prior art, a mincer is provided to solve the problem in the present invention that in the mincing process of the mincer, when materials are added to the container, the cover body needs to be disassembled again, which is very troublesome.

In order to solve the above technical problem, the present invention adopts the following technical solution: a mincer comprises:
a container, which is provided with a cavity for accommodating an object and provided with an opening communicated with the cavity;
a cover body, which is detachably installed on the container to seal the opening and provided with a feeding port communicated with the cavity; and
a flipping cover, which is hinged with the cover body and rotated to cover or expose the feeding port.

In the present invention, when the materials need to be added for the second time, the flipping cover is turned over to expose the feeding port. The materials are added for the second time into the container through the feeding port, and then the flipping cover is turned over again, so that the flipping cover covers the feeding port, so as to prevent the inside materials from flying out of the feeding port when the mincer is operated, and to protect the safety of a user. In this way, the materials can be added for the second time in the process of the operation of the mincer, without the need to disassemble the cover body, which can shorten the processing time and save time and effort.

Preferably, one end of the flipping cover away from a hinge point is clamped with the cover body through a clamping element. Thus, the flipping cover can be effectively fixed on the cover body to prevent the flipping cover from bouncing and exposing the feeding port.

Preferably, the clamping element comprises a connecting plate and a clamping block; the connecting plate is installed at one end of the flipping cover away from the hinging point; the clamping block is installed at one side of the connecting plate close to the flipping cover; and the cover body is provided with a clamping groove matched with the clamping block. When the flipping cover covers the feeding port, the clamping block is clamped into the clamping groove, so as to fix one end of the cover body away from the hinging point. When the flipping cover needs to be turned over, the connecting plate is pulled outward to deform the connecting plate elastically. After the clamping block is driven to separate from the clamping groove, the flipping cover can rotate.

Preferably, the clamping element and the flipping cover are integrally formed, which can reduce the production procedures.

Preferably, one end of the clamping block away from the flipping cover is provided with a bevel which is inclined toward the other end of the clamping block. Through the arrangement of the bevel, the clamping block can be inserted into the clamping groove more conveniently.

Preferably, the cover body is provided with an avoidance groove matched with the flipping cover, the flipping cover is installed in the avoidance groove, and an end surface of the flipping cover is flush with an end surface of the cover body after the flipping cover covers the feeding port. When the flipping cover covers the feeding port, the flipping cover is located in the avoidance groove, and an upper end surface of the flipping cover is flush with an upper end surface of the cover body, so as to reduce bulges and improve the aesthetics and hand feel of the mincer.

Preferably, a plug is installed at one side of the flipping cover close to the feeding port, and the plug is matched with the feeding port. By rotating the flipping cover, the plug moves into the feeding port, which can reduce the residues of the materials on an inner side wall of the feeding port to facilitate later cleaning.

Preferably, the cover body comprises an upper cover and a lower cover, the upper cover and the lower cover are detachably connected, and the upper cover and the lower cover are enclosed into a hollow cavity. Thus, a driving mechanism of the mincer can be installed in the hollow cavity on the cover body.

Preferably, the cover body is provided with a drainage hole communicated with the hollow cavity. Thus, when water enters the inner hollow cavity after the cover body is cleaned, the water can be effectively discharged through the drainage hole to keep the inside of the cover body dry.

Preferably, the drainage hole is concave downward, which is more convenient for discharging the water in the hollow cavity.

Compared with the prior art, the present invention has at least the following advantages:

1. When the materials need to be added for the second time, the flipping cover is turned over to expose the feeding port. The materials are added for the second time into the container through the feeding port, and then the flipping cover is turned over again, so that the flipping cover covers the feeding port, so as to prevent the inside materials from flying out of the feeding port when the mincer is operated, and to protect the safety of a user. In this way, the materials can be added for the second time in the process of the operation of the mincer, without the need to disassemble the cover body, which can shorten the processing time and save time and effort.

2. By rotating the flipping cover, the plug moves into the feeding port, which can reduce the residues of the materials on an inner side wall of the feeding port to facilitate later cleaning.

3. Through the design of the drainage hole, when water enters the inner hollow cavity after the cover body is cleaned, the water can be effectively discharged through the drainage hole to keep the inside of the cover body dry.

### DESCRIPTION OF THE DRAWINGS

To more clearly describe specific embodiments of the present invention, the drawings required to be used in the specific embodiments will be simply presented below. In all drawings, the components or parts are not necessarily drawn to actual scale.

FIG. 1 is a three-dimensional diagram of a mincer provided in an embodiment of the present invention.

FIG. 2 is a three-dimensional diagram of a cover body provided in an embodiment of the present invention.

FIG. 3 is a three-dimensional diagram of a flipping cover provided in an embodiment of the present invention.

FIG. 4 is a three-dimensional diagram of a lower cover provided in an embodiment of the present invention.

Reference signs: 1—container, 2—cover body, 21—feeding port, 22—avoidance groove, 23—upper cover, 24—lower cover, 25—hollow cavity, 26—drainage hole, 27—clamping groove, 3—flipping cover, 4—clamping element, 41—connecting plate, 42—clamping block, 43—bevel, and 5—plug.

### DETAILED DESCRIPTION OF PREFERRED EMBODIMENTS

Embodiments of the technical solutions of the present invention will be described below in detail in combination with drawings. The following embodiments are only used for more clearly illustrating the technical solutions of the present invention, and thus are only used as examples, not used for limiting the protection scope of the present invention.

It should be understood in the present invention that terms such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. indicate direction or position relationships shown based on the drawings, and are only intended to facilitate the description of the present invention and the simplification of the description rather than to indicate or imply that the indicated device or element must have a specific direction or constructed and operated in a specific direction, and therefore, shall not be understood as a limitation to the present invention.

In the present invention, unless otherwise specifically regulated and defined, terms such as “installation”, “connected”, “connection”, “fixation”, etc. shall be understood in broad sense. For example, “connection” may refer to fixed connection or detachable connection or integral connection, may refer to mechanical connection or electrical connection, and may refer to direct connection or indirect connection through an intermediate medium or inner communication of two elements or mutual interaction between two elements. For those ordinary skilled in the art, the specific meanings of the above terms in the present invention may be understood according to specific conditions.

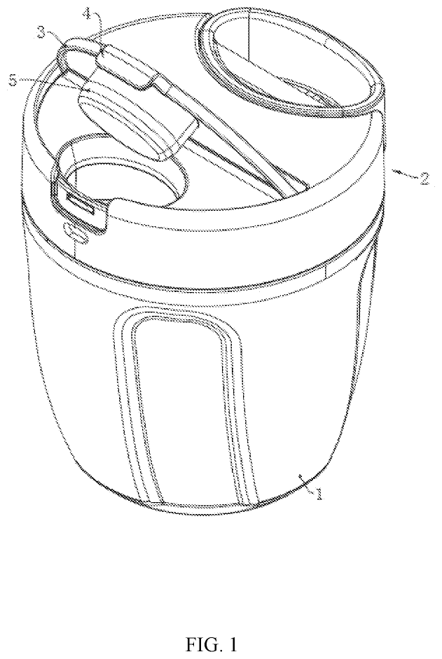

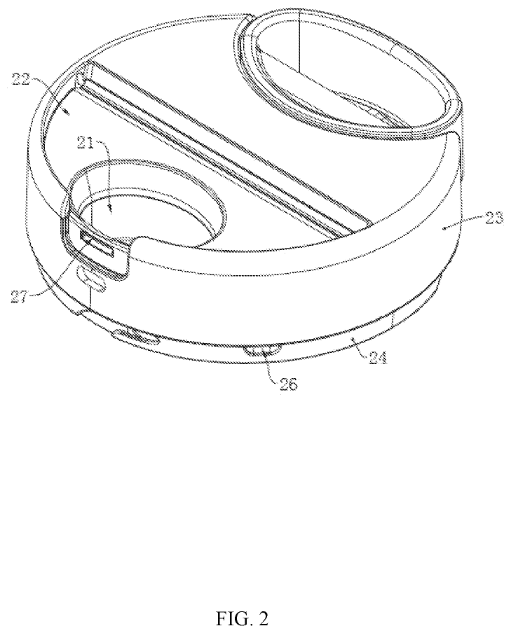

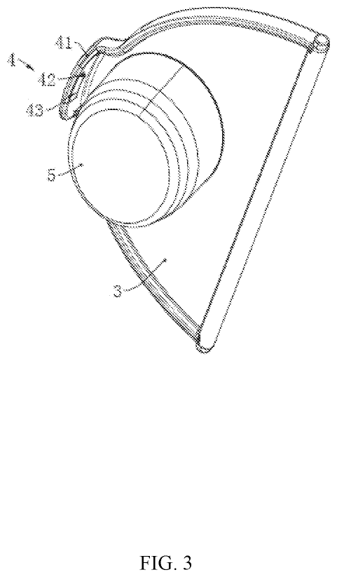

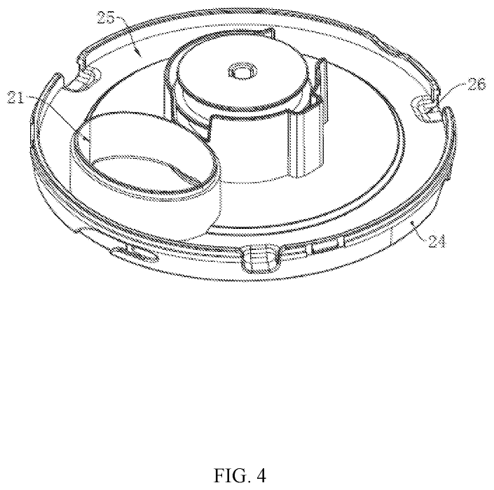

As shown in FIG. 1 to FIG. 4, in an embodiment provided by the present invention, a mincer comprises: a container 1, a cover body 2 and a flipping cover 3. The cover body 2 is detachably installed on the container 1, and the cover body 2 is provided with a feeding port 21; and one end of the flipping cover 3 is hinged with the cover body 2 to cover the feeding port 21. When materials need to be added for the second time, the flipping cover 3 is turned over to expose the feeding port 21. The materials are added for the second time into the container 1 through the feeding port 21, and then the flipping cover 3 is turned over again, so that the flipping cover 3 covers the feeding port 21, so as to prevent the inside materials from flying out of the feeding port 21 when the mincer is operated, and to protect the safety of a user. In this way, the materials can be added for the second time in the process of the operation of the mincer, without the need to disassemble the cover body 2, which can shorten the processing time and save time and effort.

As shown in FIG. 1 to FIG. 4, in other embodiments, one end of the flipping cover 3 away from a hinge point is clamped with the cover body 2 through a clamping element 4. Thus, the flipping cover 3 can be effectively fixed on the cover body 2 to prevent the flipping cover 3 from bouncing and exposing the feeding port 21.

As shown in FIG. 1 to FIG. 4, in other embodiments, the clamping element 4 comprises a connecting plate 41 and a clamping block 42; the connecting plate 41 is installed at one end of the flipping cover 3 away from the hinging point; the connecting plate 41 and the flipping cover 3 are arranged perpendicular to each other; the clamping block 42 is installed at one side of the connecting plate 41 close to the flipping cover 3; and the cover body 2 is provided with a clamping groove 27 matched with the clamping block 42. Further, the clamping element 4 and the flipping cover 3 are integrally formed, which can reduce the production procedures. Specifically, when the flipping cover 3 covers the feeding port 21, the clamping block 42 is clamped into the clamping groove 27, so as to fix one end of the cover body 2 away from the hinging point. When the flipping cover 3 needs to be turned over, the connecting plate 41 is pulled outward to deform the connecting plate 41 elastically. After the clamping block 42 is driven to separate from the clamping groove 27, the flipping cover 3 can rotate. Further, one end of the clamping block 42 away from the flipping cover 3 is provided with a bevel 43 which is inclined toward the other end of the clamping block 42. Through the arrangement of the bevel 43, the clamping block 42 can be inserted into the clamping groove 27 more conveniently.

As shown in FIG. 1 to FIG. 3, in other embodiments, the cover body 2 is provided with an avoidance groove 22 matched with the flipping cover 3, the flipping cover 3 is installed in the avoidance groove 22, and an end surface of the flipping cover 3 is flush with an end surface of the cover body 2 after the flipping cover 3 covers the feeding port 21. Specifically, when the flipping cover 3 covers the feeding port 21, the flipping cover 3 is located in the avoidance groove 22, and an upper end surface of the flipping cover 3 is flush with an upper end surface of the cover body 2, so as to reduce bulges and improve the aesthetics and hand feel of the mincer.

As shown in FIG. 1 to FIG. 3, in another embodiment, a plug 5 is installed at one side of the flipping cover 3 close to the feeding port 21, and the plug 5 is matched with the feeding port 21. By rotating the flipping cover 3, the plug 5 moves into the feeding port 21, which can reduce the residues of the materials on an inner side wall of the feeding port 21 to facilitate later cleaning. Further, one end of the feeding port 21 close to the plug 5 is provided with a chamfer. Thus, the plug 5 can conveniently enter the feeding port 21. Specifically, the chamfer can be a rounded corner, a symmetrical bevel, or an asymmetric bevel.

As shown in FIG. 1 to FIG. 4, in other embodiments, the cover body 2 comprises an upper cover 23 and a lower cover 24, the upper cover 23 and the lower cover 24 are detachably connected, and the upper cover 23 and the lower cover 24 are enclosed into a hollow cavity 25. Thus, a driving mechanism of the mincer can be installed in the hollow cavity 25 on the cover body 2. Further, the cover body 2 is provided with a drainage hole 26 communicated with the hollow cavity 25. The drainage hole 26 is communicated with the hollow cavity 25 inside the cover body 2. Thus, when water enters the inner hollow cavity 25 after the cover body 2 is cleaned, the water can be effectively discharged through the drainage hole 26 to keep the inside of the cover body 2 dry. Further, the drainage hole 26 is concave downward, which is more convenient for discharging the water in the hollow cavity 25.

The above embodiments are only used to illustrate the technical solution of the present invention, not to limit the technical solution. Although the present invention is described in detail by referring to the above embodiments, those ordinary skilled in the art shall understand that the technical solution recorded in each embodiment can be amended, or some or all of technical features can be replaced equivalently. The amendments or replacements shall not make the essence of the corresponding technical solution depart from the scope of the technical solution of each embodiment of the present invention, and shall be covered within the scope of the claims and the description of the present invention.

We claim:

1. A mincer, comprising:
a container, which is provided with a cavity for accommodating an object and provided with an opening communicated with the cavity;
a cover body, which is detachably installed on the container to seal the opening and provided with a feeding port communicated with the cavity; and
a flipping cover, which is hinged with the cover body and rotated to cover or expose the feeding port.

2. The mincer according to claim 1, wherein one end of the flipping cover away from a hinge point is clamped with the cover body through a clamping element.

3. The mincer according to claim 2, wherein the clamping element comprises a connecting plate and a clamping block; the connecting plate is installed at one end of the flipping cover away from the hinging point; the clamping block is installed at one side of the connecting plate close to the flipping cover; and the cover body is provided with a clamping groove matched with the clamping block.

4. The mincer according to claim 3, wherein the clamping element and the flipping cover are integrally formed.

5. The mincer according to claim 3, wherein one end of the clamping block away from the flipping cover is provided with a bevel which is inclined toward the other end of the clamping block.

6. The mincer according to claim 1, wherein the cover body is provided with an avoidance groove matched with the flipping cover, the flipping cover is installed in the avoidance groove, and an end surface of the flipping cover is flush with an end surface of the cover body after the flipping cover covers the feeding port.

7. The mincer according to claim 1, wherein a plug is installed at one side of the flipping cover close to the feeding port, and the plug is matched with the feeding port.

8. The mincer according to claim 1, wherein the cover body comprises an upper cover and a lower cover, the upper cover and the lower cover are detachably connected, and the upper cover and the lower cover are enclosed into a hollow cavity.

9. The mincer according to claim 8, wherein the cover body is provided with a drainage hole communicated with the hollow cavity.

10. The mincer according to claim 9, wherein the drainage hole is concave downward.
